(19) United States
(12) Patent Application Publication
(10) Pub. No.: US 2024/0164361 A1
(43) Pub. Date: May 23, 2024

(54) FISHING TACKLE STORAGE SYSTEM AND METHOD

(71) Applicant: Raleigh Tackle LLC, Tyler, TX (US)

(72) Inventor: David DOLLAHITE, Karnack, TX (US)

(73) Assignee: Raleigh Tackle LLC, Tyler, TX (US)

(21) Appl. No.: 17/990,933

(22) Filed: Nov. 21, 2022

(51) Int. Cl. A01K 97/06

(52) U.S. Cl. CPC A01K 97/06

(57) ABSTRACT

A tackle storage device may be provided. The tackle storage device may have a panel with at least one lure retaining hole disposed therethrough. The at least one lure retaining hole may have a round central portion, a first narrow portion, and a second narrow portion projecting from the round central portion. The first and second narrow portions may project in opposite directions from the round central portion, and one of the first or second narrow portions may intersect a perimeter edge of the panel, creating an open end of the lure retaining hole.

### BACKGROUND

Effective storage of fishing tackle, such as fishing hooks, lures, baits, lines, sinkers, or floats, is important for organization, safe keeping, easy access, and efficient transportation to and from remote fishing locations. Tackle storage systems allow these and other items of fishing tackle to be organized so as to be easily retrievable by the fisherman. Tackle storage also ensures that potentially fragile items are kept spaced apart from one another or are otherwise kept protected from damage, and ensure that certain items of fishing tackle, such as lines, lures or hooks, do not become tangled up with one another.

Most conventional tackle storage systems are boxes, typically formed from plastic or sheet metal, having several shelves each having a variety of differently-sized compartments, each of which is sized to retain some type of item of fishing tackle. For example, a tackle box might have a shelf with a number of long, thin compartments, each intended to be used to hold a fishing lure laid flat in the compartment. Typically, these shelves are stored such that, when a user opens the top lid of the tackle box, the shelves are splayed outward such that the user can see many of the compartments of each shelf.

However, certain problems with these designs exist. For example, when a fishing lure is put away after use, it will typically be wet; putting these lures away in a box-type container may cause water to pool in the box-type container, causing or accelerating rusting of any of the metal parts of the lure, such as an integrated fishhook. This problem can be particularly acute for users that engage in saltwater fishing; salt residue can cause similar problems even if the lures are allowed to dry before being put away, often necessitating that the lures and even the compartments of the tackle box used to transport the lures be specifically cleaned after use.

Further, despite the fact that many tackle boxes are configured to splay their shelves outward to some degree in order to make their compartments more accessible and more visible, fishing tackle located in a tackle box is often difficult for a user to sort through. For example, a particular compartment may be obscured by a shelf even in an open position, making it difficult for the user to identify the contents of that compartment. In another example, multiple items of fishing tackle may be stacked on top of one another in the same compartment, obscuring from view the items of fishing tackle located lower in the stack.

Also, storing crank-baits, spinner-baits, and other lures inside compartments of a tackle box can result in damage to the paint and finish on the lures. If lures are stored inside compartments of a tackle box, when the tackle box is moved, the lures inside the compartments can shift position inside of the tackle box. If the tackle box is moved sharply, such as if the tackle box is dropped or falls from some height and impacts the ground, the lures can impact the surfaces of the compartments of the tackle box, potentially causing damage to the lures. Further, even routine movement of the tackle box can cause the positions of the lures to constantly shift against the surfaces of the compartments, creating friction between the lures and the surfaces of the compartments, which can damage the paint and finish of the lures.

### SUMMARY

An exemplary embodiment of a tackle storage device may be provided. The tackle storage device may have a panel with at least one lure retaining hole disposed therethrough. The at least one lure retaining hole may have a round central portion, a first narrow portion, and a second narrow portion projecting from the round central portion. The first and second narrow portions may project in opposite directions from the round central portion, and one of the first or second narrow portions may intersect a perimeter edge of the panel, creating an open end of the lure retaining hole.

An exemplary embodiment of another tackle storage device may also be provided. The tackle storage device may have a container with at least one board supporting flange disposed on an interior wall of the container. The tackle storage device may also have a board with at least one lure retaining hole disposed therethrough. The board may be suspended by the at least one board supporting flange within the interior of the container. The board may be suspended substantially parallel to a floor of the container.

### BRIEF DESCRIPTION OF THE FIGURES

Advantages of embodiments of the present invention will be apparent from the following detailed description of the exemplary embodiments thereof, which description should be considered in conjunction with the accompanying drawings in which like numerals indicate like elements, in which:

FIG. 1 depicts an exemplary embodiment of a tackle storage device.

FIG. 2 depicts an exemplary embodiment of a tackle storage device.

FIG. 3 depicts an exemplary embodiment of a tackle storage device.

FIG. 4 depicts an exemplary embodiment of a tackle storage device.

FIG. 5 depicts an exemplary embodiment of a tackle storage device.

FIG. 6 depicts an exemplary embodiment of a tackle storage device.

FIG. 7 depicts an exemplary embodiment of a tackle storage device.

FIG. 8 depicts an exemplary embodiment of a tackle storage device.

### DETAILED DESCRIPTION

Aspects of the invention are disclosed in the following description and related drawings directed to specific embodiments of the invention. Alternate embodiments may be devised without departing from the spirit or the scope of the invention. Additionally, well-known elements of exemplary embodiments of the invention will not be described in detail or will be omitted so as not to obscure the relevant details of the invention. Further, to facilitate an understanding of the description discussion of several terms used herein follows.

As used herein, the word “exemplary” means “serving as an example, instance or illustration.” The embodiments described herein are not limiting, but rather are exemplary only. It should be understood that the described embodiments are not necessarily to be construed as preferred or advantageous over other embodiments. Moreover, the terms “embodiments of the invention”, “embodiments” or “invention” do not require that all embodiments of the invention include the discussed feature, advantage or mode of operation.

According to an exemplary embodiment, and referring generally to the Figures, various exemplary implementations of a tackle storage system may be disclosed. In some embodiments, the tackle storage system may allow a user to more easily view and access certain items of fishing tackle, such as lures. The tackle storage system may also make it easier to clean certain items of fishing tackle, such as fishing lures. Various configurations of the storage system may be understood; for example, according to some exemplary embodiments, a tackle storage system may be implemented as a tackle box with hard sides, a bag with soft sides, a hybrid container with soft and hard sides, as a standalone component, or as a component inserted in a separate container or storage compartment, such as a panel capable of insertion in a cabinet or storage container.

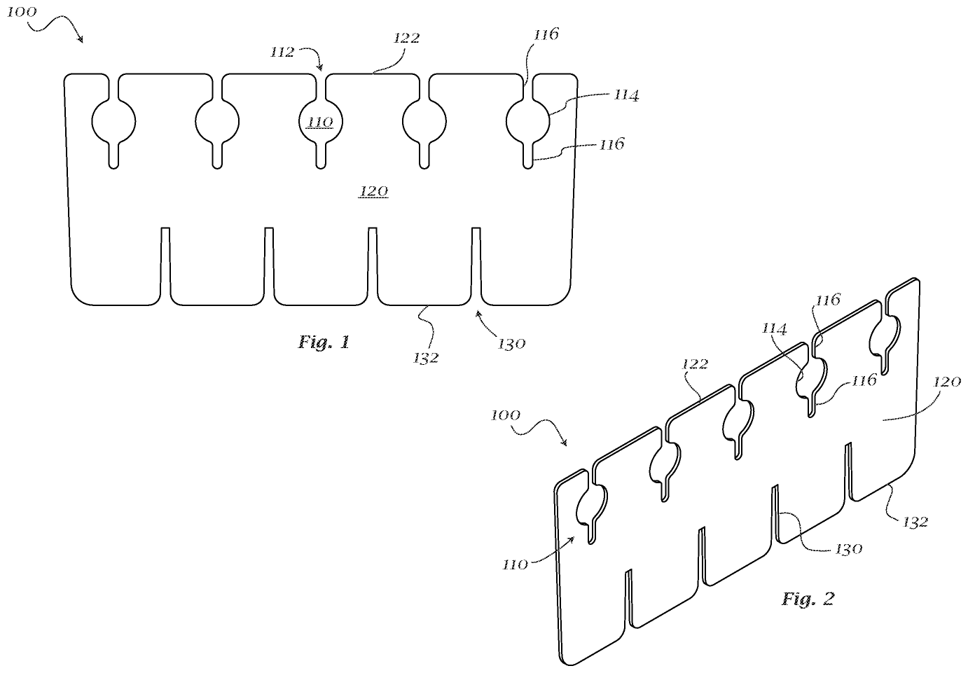

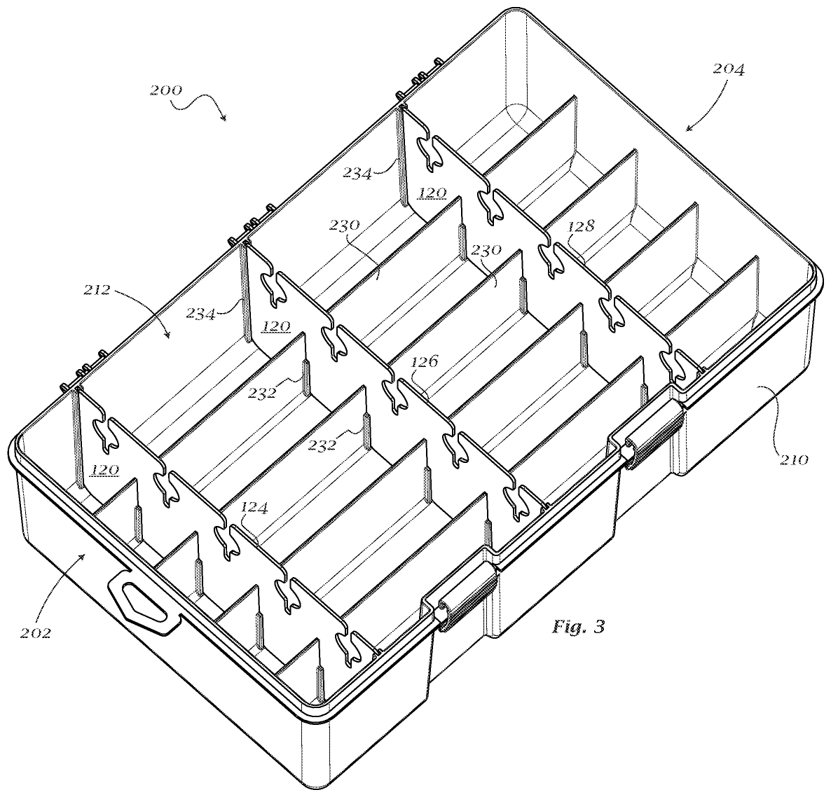

Referring now to exemplary FIG. 1, a tackle storage system 100 may be provided. Tackle storage system 100 may include at least one lure retaining hole 110 disposed in a panel 120 or wall. The at least one lure retaining hole 110 may be disposed adjacent a perimeter edge 122 of panel 120. According to an exemplary embodiment, a lure retaining hole 110 may intersect edge 122 such that the lure retaining hole 110 may have an open end 112, which may form a gap in the perimeter edge 122 of panel 120. Lure retaining hole 110 may have a wide, central portion 114, and one or more narrow portions 116 extending away from the wide portion 114. According to an exemplary embodiment, wide portion 114 may be substantially round. In operation, a lure that has an integrated diving lip or crankbait lip, or a lure to which a diving lip can be attached, may be inserted through the lure retaining hole 110 by, for example, by turning the lure sideways so that one or more sides of the diving lip is substantially in-line with one or more narrow portions 116 of the lure retaining hole 110. The diving lip of the lure may then be inserted through the lure retaining hole 110. The lure may then be turned when the diving lip of the lure is all the way through the lure retaining hole 110, preventing the lure from being removed from the lure retaining hole 110 without turning the lure back to a position similar to the one it was in when inserted into the lure retaining hole 110. Lures may also be inserted into the lure retaining holes 110 in another manner or may be coupled to more than one lure retaining hole 110, for example by looping the lure or hooks thereof around the space between multiple lure retaining holes 110, as desired.

According to an exemplary embodiment, a lure, such as a crankbait, may be inserted into the at least one lure retaining hole 110. As discussed above, the lure may have a lip, which protrudes from a body of the lure. The lure body may have a nose end, from which the lip protrudes. A lure may be inserted into lure retaining hole 110 by turning the lure on its side and sliding the lure lip-first into retaining hole 110. The lure may optionally be slid into retaining hole 110 at an angle in the vertical direction, such as a 45-degree angle, to facilitate insertion into retaining hole 110. The angle of the lure may work in conjunction with open end 112 to allow the lip to pass through the lure retaining hole 100 more easily. Furthermore, open end 112 may have rounded or tapered corners, which may facilitate insertion or removal of a lure lip by providing a forgiving opening and allow for manipulation of the lure during insertion. Open end 112 may also facilitate, hanging a lure by a hook or securing a lure by wrapping line through one or more lure retaining hole 110. The lure may be inserted until a nose potion touches or abuts an edge of the retaining hole 110 or panel 120. Once the lure is inserted completely, it may then be rotated back to an upright position, which may, for example, be approximately 90 degrees from its side position. According to an exemplary embodiment, at least one lure retaining hole may be disposed in panel 120, such that one or more lure retaining hole 110 may intersect an edge 122, which may optionally be an upper edge of panel 120 when panel 120 is secured in a tackle storage orientation, which may be in a tackle storage housing. According to still further exemplary embodiments, at least one lure retaining hole 110 disposed in panel 120 may intersect an of panel 120, such as edge 122, and at least one lure retaining hole 110 may be disposed in panel 120 such that it does not intersect any edges. Still further, lure retaining holes 110 disposed within a panel 120 may optionally be the same size or may optionally be varied sizes. For example, lure retaining holes 110 may have different size perimeters or surface area. Lure retaining holes 110 may also optionally have different size portions, such as different sized wide portions 114 or one or more different sized narrow portion 116.

According to an exemplary embodiment, a lure, such as a crankbait, may be removed by applying pressure on a bill or lip of the lure to push down on the lip. In conjunction with the pressure applied on a lip, which may angle the lure in a vertical orientation, or which may straighten the lure horizontally to facilitate aligning the lip with the lure retaining hole 110. The lure may also be rotated to one side, which may align the lip with one or more narrow portions 116 of the lure retaining hole and allow the lip to be slid out of the lure retaining hole 110 and the lure removed.

Panel 120 may have one or more lure retaining holes 110 disposed therethrough, as described in detail above. Panel 120 may have, for example, two or more lure retaining holes 110 disposed along a top edge thereof. According to other alternative exemplary embodiments, panel may optionally have at least one lure retaining hole 110, which may intersect an edge thereof, and at least one lure retaining hole, which may be disposed completely within an interior surface of panel 120. Furthermore, according to some embodiments, panel 120 may further have at least one indentation or slot 130 protruding through a bottom edge 132. Slot 130 may be capable of receiving or fitting over structure of a tackle storage container, such as a tackle storage box.

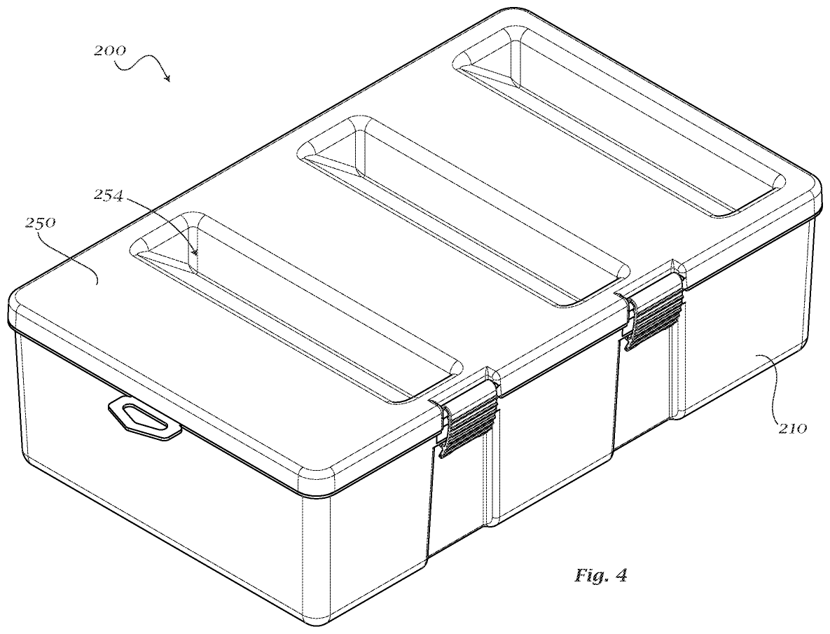

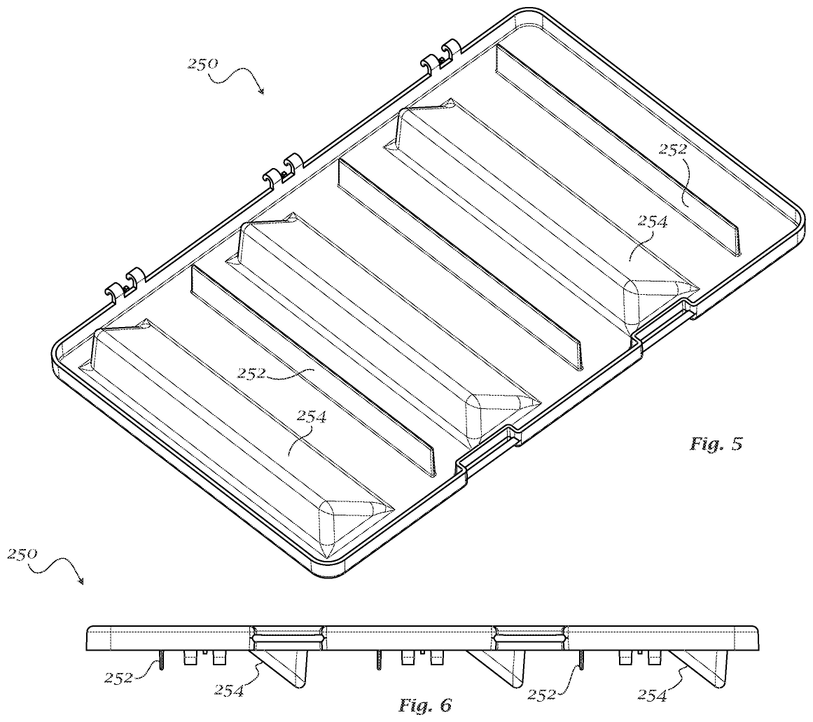

Now referring to exemplary FIGS. 3-6, a tackle storage container 200 may be provided. Tackle storage container 200 may include a body or housing 210, which may enclose a cavity 212. One or more panels 120 may be disposed within cavity 212. Slots 130 of panels 120 may secure panels 120 on one or more dividers 230 within cavity 212. Furthermore, dividers 230 may have one or more alignment flanges 232, which may align or secure panels 120 at a desired location along an elongated axis of dividers 230. Similar flanges 234 may be disposed on an interior of housing 210.

According to the exemplary embodiment shown in FIG. 3, for example, a tackle container 200 may have three panels 120, which may each have five lure retaining holes 110. Panels 120 may be disposed on 4 dividers 230, which may not only engage slot 130 to support and hold panels 120 in place, but which may also serve as dividers to create compartments, which may separate lures when stored within container 200. This may prevent entanglement of hooks or other undesirable contact between lures in a storage orientation.

Tackle storage container 200 may further include a lid 250. Lid 250 may have one or protrusion 252, which may protrude toward an interior of storage container 200. Protrusion 252 may optionally be substantially plate, panel, or rectangularly shaped; however, protrusion 252 may be a variety of shapes, as may be understood by a person having ordinary skill in the art. The one or more protrusion 252 may be aligned in conjunction with one or more panel 120, such that the protrusion 252 projects on a side of panel 120 through which a lure bill may project. Therefore, protrusion 252 may engage or contact a lure bill when the lure is inserted in a lure retaining hole 110 of panel 120. The contact or engagement of protrusion 252 may apply pressure on the lure of the bill, causing the lure to level or sit closer to horizontal in the container 200. Due to the weight balance of a lure, lures may naturally sag toward a hook side when inserted in lure retaining hole 110, which may cause the lure or its hooks to contact a bottom surface or to be less stable or secure within lure retaining hole 110. Protrusion 252 applying pressure to the lure bill may angle the lure and its hooks away from the container floor or bottom surface and may cause the lure to be held more securely in lure retaining hole 110, as would be understood by a person having ordinary skill in the art.

According to still some further exemplary embodiments, lid 250 may have other angled indentations 254, which may protrude into an interior of container 200 and may optionally engage a top or back of a lure for stability. According to exemplary FIGS. 3-6, it may be realized that panels 120 may be distributed within container 200 to maximize space. Alternatively, panels 120 may be distributed evenly within container 200 such that lures can be inserted in either direction of each pane. According to the embodiment shown in FIGS. 3-6, there may be three panels 120 (124, 126, and 128), which may be evenly spaced, but a first of which, panel 124, may be closer to a first side 202 of container 200 than the last of which, panel 128, may be to a second side 204. This may be because a bill or lip of a lure may not be as long as a body of the lure and therefore, by skewing the panels 120 within container 200, the space may be more efficiently utilized when lures are inserted in a uniform direction, facing side 202. Lid protrusions may be aligned with panels 120, such that protrusions 252 project into the container of a lip or bill side of panels 120, or as in the embodiment of FIGS. 3-6, protrusions 252 may project on a side of panels 120 closer to a first side 202 of container 200. In some compartments, a body or tail of a lure may both be disposed within the compartment. For example, a body or tail of a lure secured in panel 124 may be dispose din the same compartment as a lip or bill of a lure secured in panel 126. According to embodiments with indentations 254, indentations 254 may be disposed proximate a separation line between a tail end of a lure and a bill of a subsequently aligned lure. Furthermore, according to some embodiments indentations 254 may be contoured or angled to correspond to a tail end of a lure.

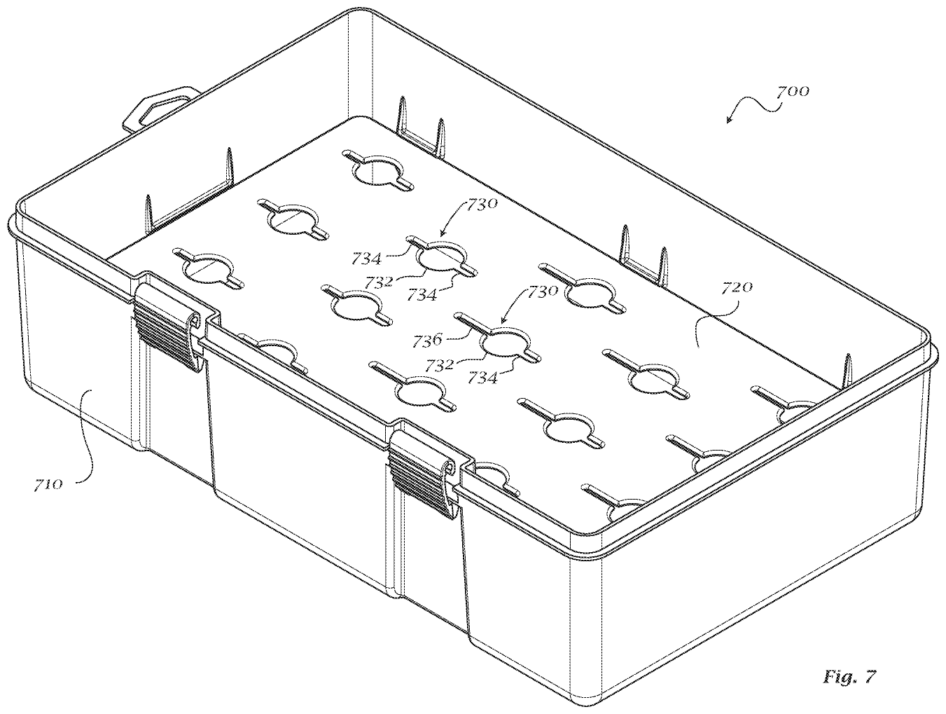

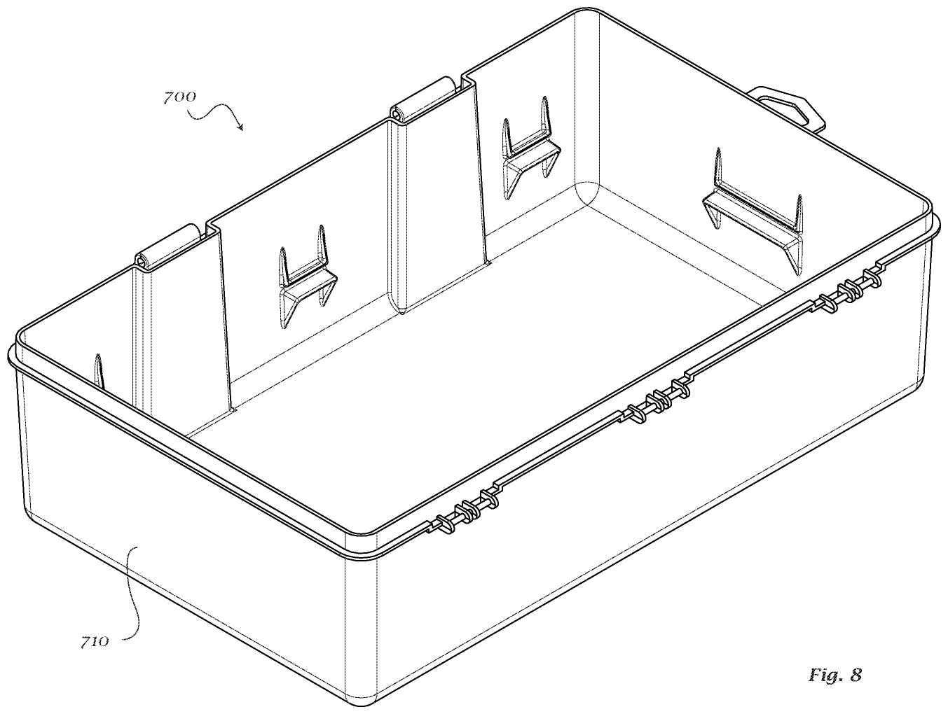

Now referring to exemplary FIGS. 7-8, another embodiment of a tackle storage device 700 may be disclosed. According to an exemplary embodiment, tackle storage device 700 may have a body 710 and a lure retaining board or panel 720. At least one retaining flange 722 may be disposed on an interior of body 710, such as an interior wall surface. The at least one retaining flange 722 may provide a lip upon which board 720 may rest when inserted within container 700. Flange 722 may optionally have a bottom lip and a top lip, which both may be configured to secure board 720 in a desired orientation. For example, board 720 may rest or secure in flange 722 such that board 720 is disposed in a horizontal manner or otherwise laying substantially parallel to a floor of container 700. Board 720 may include one or more lure retaining hole 730 disposed therethrough. According to an exemplary embodiment, board 720 may have a plurality of lure retaining holes 730. Lure retaining holes 730 may have a wide central portion 732 and at least one narrow portion 734 projecting therefrom. According to some exemplary embodiments, lure retaining hole 730 may have two narrow portions 734 projecting from wide central portion 732 in opposite directions. Still further, according to some embodiments, some or all of the lure retaining holes 730 disposed in board 720 may optionally have differently shaped or sized narrow portions 734 projecting therefrom. For example, a lure retaining hole 730 may have a long narrow portion 734 projecting opposite short narrow portion 736. According to some embodiments, lure retaining holes 730 may be disposed in a series of rows and each row may be staggered with respect to adjacent rows.

Tackle storage device 700 may further facilitate storage of various additional baits or lures, such as spinner baits. For example, by providing a horizontal surface with lure retaining holes disposed therein, hooks or elements of spinner baits may be hooked or slid into lure retaining holes. According to still further exemplary embodiments, a spinner bait may be pinched such that it can pass through lure retaining hole and be secured within narrow portions of a lure retaining hole with resistance when attempting to return to its natural shape.

In some embodiments, different sizes or shapes of lure retaining holes may be understood and may be integrated into tackle storage device or portion thereof, such as a panel 120 or 720, as desired. For example, according to an exemplary embodiment, small, medium, and large-sized holes all substantially resembling one another in shape may each be present in some quantity on a panel. According to some embodiments, the differently sized lure retaining holes may have the same shape. According to still further exemplary embodiments, a tackle storage device having multiple panels 120 may optionally have differently sized lure retaining holes disposed within a single panel or may have uniformly sized lure retaining holes within each panel, but different removable panels having different sizes. According to such embodiments, panels may be color coded to indicate different sizes. For example, a red tint may indicate a panel with large lure retaining holes for larger lures, a green tint may indicate a panel with medium lure retaining holes for medium lures, and a yellow tint may indicate a panel with smaller lure retaining holes for smaller lures or crankbaits. The colors may be any color as desired. According to still further exemplary embodiments, color coding indicating different sizes may be used around specific lure retaining holes, such as tinting an area around or an edge of an individual lure retaining hole, such as lure retaining hole 730 or 110. This may allow different sizes or shapes of lures to be inserted onto or otherwise retained on the lure retaining board, as desired.

Furthermore, lure retaining holes may have rounded, contoured, tapered, or sharp edges, as may be desired. Lure retaining holes may also have a rigidly defined or set perimeter shape. Narrow portions may create narrow channels or gaps. In other embodiments, narrow portions may be deformable and may be slits, which may allow a lure lip to pass through by deformation of the material and when sufficient pressure is applied, as would be understood by a person having ordinary skill in the art. Furthermore, some or all of the perimeter of lure retaining holes may have a rubber or other soft material, which safeguard inserted lures. Furthermore, lure retaining holes may have a liner or material that provides added grip to a secured lure.

In some exemplary embodiments, some or all of a tackle storage device or parts thereof, such as a panel, may be constructed from a transparent, translucent, semi-transparent, or semi-translucent material. According to exemplary embodiments, materials could include clear or semi-clear acrylic, polypropylene, plastics, polymers, composites, or other material materials, as would be understood by a person having ordinary skill in the art. Some embodiments may allow items on the other side of a panel or tackle storage device to be seen by a user looking at one side of the panel. In other embodiments, the material may be opaque. In some embodiments, the sections of the device surrounding some or all of each lure retaining hole may be constructed from a different material; for example, in some embodiments, a panel having a number of lure retaining holes may have the perimeters of each of those lure retaining holes reinforced with a stronger material, such as a thicker portion of the same material or a different material, e.g. polymers, metals, ceramics, composites, rubbers, plastics, etc., in order to better prevent crack formation and proliferation around the lure retaining holes. According to each embodiment, panels and lure retaining holes may be arranged to allow drainage or drying of lures in a storage position.

The foregoing description and accompanying figures illustrate the principles, preferred embodiments and modes of operation of the invention. However, the invention should not be construed as being limited to the particular embodiments discussed above. Additional variations of the embodiments discussed above will be appreciated by those skilled in the art (for example, features associated with certain configurations of the invention may instead be associated with any other configurations of the invention, as desired).

Therefore, the above-described embodiments should be regarded as illustrative rather than restrictive. Accordingly, it should be appreciated that variations to those embodiments can be made by those skilled in the art without departing from the scope of the invention as defined by the following claims.

What is claimed is:

1. A tackle storage device, comprising:
a panel with at least one lure retaining hole disposed therethrough, wherein the at least one lure retaining hole has a round central portion, a first narrow portion, and a second narrow portion projecting from the round central portion, wherein the first and second narrow portions project in opposite directions from the round central portion, and wherein one of the first or second narrow portions intersects a perimeter edge of the panel, creating an open end of the lure retaining hole.

2. The tackle storage device of claim 1, wherein the panel further comprises at least one engagement slot disposed in the panel and configured to engage a storage container.

3. The tackle storage device of claim 1, wherein the open end of the lure retaining hole is disposed in a top edge of the panel.

4. The tackle storage device of claim 2, wherein the panel is disposed in a storage container.

5. The tackle storage device of claim 4, wherein the storage container has one or more divider configured to engage the slot disposed in the panel.

6. The tackle storage device of claim 5, wherein the one or more divider has alignment flanges to secure the panel in a desired orientation within the storage container.

7. The tackle storage device of claim 6, further comprising at least one divider and at least two panels, wherein each panel has at least two lure retaining holes.

8. The tackle storage device of claim 6, further comprising four dividers and three panels, wherein each panel comprises five lure retaining holes.

9. The tackle storage device of claim 1, wherein the first and second narrow portions of at least one of the at least one lure retaining hole are different lengths.

10. The tackle storage device of claim 4, wherein the storage container further comprises a lid with at least one protrusion projecting into an interior of the storage container when closed and wherein the at least one protrusion is configured to engage a lure disposed in the at least one lure retaining hole.

11. A tackle storage device, comprising:
a container with at least one board supporting flange disposed on an interior wall of the container; and
a board having at least one lure retaining hole disposed therethrough, wherein the board is suspended by the at least one board supporting flange within an interior of the container and wherein the board is suspended substantially parallel to a floor of the container.

12. The tackle storage device of claim 11, the at least one lure retaining hole has a round central portion, a first narrow portion, and a second narrow portion projecting from the round central portion, wherein the first and second narrow portions project in opposite directions from the round central portion.

13. The tackle storage device of claim 12, wherein the first and second narrow portions of at least one of the at least one lure retaining hole are different lengths.

14. The tackle storage device of claim 13, further comprising a plurality of lure retaining holes, wherein the lure retaining holes are arranged in a series of rows.

15. The tackle storage device of claim 14, wherein the lure retaining holes of each row are staggered with respect to adjacent rows.
